(19) United States
(12) Patent Application Publication
(10) Pub. No.: US 2006/0184456 A1
(43) Pub. Date: Aug. 17, 2006

(54) Vehicle-based wireless identification system

(76) Inventor: Christopher G. de Janasz, Charlottesville, VA (US)

Correspondence Address: Michael N Haynes, 1341 Huntersfield Close, Keswick, VA, 22947, US

(21) Appl. No.: 10/563,187

(22) PCT Filed: Jul. 21, 2004
(86) PCT No.: PCT/US04/23280

§ 371 Date: Dec. 30, 2005

Related U.S. Application Data
(60) Provisional application No. 60/488,951, filed on Jul. 21, 2003.

(51) Int. Cl. G06Q 99/00

(52) U.S. Cl. 705/72

(57) ABSTRACT

Certain exemplary embodiments comprise a method comprising: receiving a signal from a transmitter, the signal comprising a unique identifier, the signal transmitted responsive to a predetermined input from a user, the signal requesting approval of a proposed transaction, transmitting the unique identifier to a central processor adapted to approve the proposed transaction if at least the unique identifier is an approval from the central processor to complete the proposed transaction, the proposed transaction involving the valid financial account associated with the unique identifier. Certain exemplary embodiments comprise a method comprising: at a central processor, receiving information originating from a transmitter, the information comprising a unique identifier, the information provided from the transmitter responsive to a predetermined input from a user, the information requesting approval of a proposed transaction, and if at least the unique identifier is associated with a valid financial account transmitting an approval to complete the proposed transaction, the proposed transaction involving the valid financial account associated with the unique identifier.

### CROSS-REFERENCES TO RELATED APPLICATIONS

This application claims priority to, and incorporates by reference herein in its entirety, pending U.S. Provisional Patent Application Ser. No. 60/488,951 (Attorney Docket No. 1043-002), filed 21 Jul. 2003.

### BRIEF DESCRIPTION OF THE DRAWINGS

A wide variety of potential embodiments will be more readily understood through the following detailed description, with reference to the accompanying drawings in which:

FIG. 1 is a flow chart of an exemplary embodiment of a method 1000 for utilizing a transmitter;

FIG. 2 is a flow chart of an exemplary embodiment of a method 2000 for utilizing a receiver;

FIG. 3 is a flow chart of an exemplary embodiment of a method 3000 for utilizing a central processor;

FIG. 4 is a block diagram of an exemplary embodiment of a system 4000; and

FIG. 5 is a block diagram of an information device 5000.

### DEFINITIONS

When the following terms are used herein, the accompanying definitions apply:
access—an ability or right to approach, enter, exit, communicate with, or make use of.
acknowledgement—a response to a communication.
amount—a quantity of money.
approval—a formal act of acceptance.
approval processor—a processor adapted to obtain and/or provide an approval for a financial transaction.
central processor—a processor communicatively coupled to a plurality of information devices via a network, the processor adapted to process transactions. A central processor can, for example, receive an encrypted message comprising a unique identifier, decrypt the encrypted message, compare the unique identifier to a list of unique identifiers associated with financial accounts, approve a transaction, reject the transaction, obtain an approval for the transaction, obtain a rejection of the transaction, transmit the approval for the transaction, and/or transmit the rejection of the transaction, etc.
code-hopping technique—a method for dynamically changing a security code used to encrypt and/or decrypt an electrical or electromagnetic transmission between a sender and a receiver. The security code can be generated via an encryption algorithm that utilizes a serial number and a plurality of predefined information bits. The security code can be changed and/or communicated with each communication between the sender and the receiver.
counter-party—an entity that agrees to and/or provides a good and/or service in exchange for consideration.
decrypt—decipher an encoded message.
encrypted—altered so as to be unintelligible by anyone without a decryption key, which is usually kept secret.
entry—a privilege or right to access a physical and/or a logical location.
financial account—a contractually formed banking, brokerage, and/or business relationship between a legally responsible entity and a separate intermediary and/or counter-party, the relationship established to facilitate and tally purchases, services, dealings, and/or other monetary transactions, the relationship having a feature via which the intermediary and/or counter-party is contractually authorized to receive reimbursement for a payment they make, defer receipt of, and/or assume liability for, on behalf of the legally responsible entity. A financial account can be a credit account, a credit card account, a charge card account, a checking account, a debit card account, a brokerage account, a PayPal account, and/or a micropayment account, etc.
financial account number—a numeric and/or alphanumeric character string uniquely associated with and/or identifying a financial account.
fixedly attached—firmly coupled, anchored, and/or joined.
headlight—a light with a reflector and lens mounted on the front of a vehicle.
high beam switch activation—via operation of an electrical switch, changing a headlight to a bright setting from a dim setting and/or changing the headlight from a dim setting to a bright setting.
information—data.
information device—any device capable of processing information, such as any general purpose and/or special purpose computer, such as a personal computer, workstation, server, minicomputer, mainframe, supercomputer, computer terminal, laptop, wearable computer, and/or Personal Digital Assistant (PDA), mobile terminal, Bluetooth device, communicator, “smart” phone (such as a Handspring Treo-like device), messaging service (e.g., Blackberry) receiver, pager, facsimile, cellular telephone, a traditional telephone, telephonic device, a programmed microprocessor or microcontroller and/or peripheral integrated circuit elements, an ASIC or other integrated circuit, a hardware electronic logic circuit such as a discrete element circuit, and/or a programmable logic device such as a PLD, PLA, FPGA, or PAL, or the like, etc. In general any device on which resides a finite state machine capable of implementing at least a portion of a method, structure, and/or or graphical user interface described herein may be used as an information device. An information device can include well-known components such as one or more network interfaces, one or more processors, one or more memories containing instructions, and/or one or more input/output (I/O) devices, one or more user interfaces, etc.
input processor—a processor adapted to receive a signal from a wireless transmitter.
instructions—directions adapted to perform a particular operation or function.
list—a sequence of information.
memory device—any device capable of storing analog or digital information, for example, a non-volatile memory, volatile memory, Random Access Memory, RAM, Read Only Memory, ROM, flash memory, magnetic media, a hard disk, a floppy disk, a magnetic tape, an optical media, an optical disk, a compact disk, a CD, a digital versatile disk, a DVD, and/or a raid array, etc.
micropayment—an electronic payment for information or services ranging from less than one dollar to less than a cent, including all values and subranges therebetween.
network—a communicatively-coupled plurality of communication devices. Examples include wired and/or wireless communications networks, such as public, private, circuit-switched, packet-switched, connection-less, virtual, radio, telephone, POTS, non-POTS, PSTN, non-PSTN, cellular, cable, DSL, satellite, microwave, twisted pair, IEEE 802.03, Ethernet, token ring, local area, wide area, IP, Internet, intranet, wireless, Ultra Wide Band (UWB), Wi-Fi, BlueTooth, Airport, IEEE 802.11, IEEE 802.11a, IEEE 802.11b, IEEE 802.11g, X-10, and/or electrical power networks, etc., and/or any equivalents thereof. A network can have any architecture, including a direct connection, a local area network, a wide area network such as the public switched telephone network and/or the Internet, an extranet, and/or a combination thereof. A network can be a packet-switched, a circuit-switched, a connectionless, or connection-oriented network or interconnected networks, or any combination thereof. Moreover, a transmission media of a network can take any form, including wireline, satellite, wireless, or a combination thereof.
non-telephonic—not transmitted via a device that converts voice and other audible sounds into a form that can be transmitted to remote locations and that converts received signals into audible sounds.
output processor—a processor adapted to transmit a message to another processor.
physical location—a materially real site.
polling—listening for information.
PIN—a predetermined sequence of characters entered via a user interface, the sequence adapted to validate or attempt to validate an authority of a user to engage in an activity.
pre-authorized—approved in advance.
predetermined—determine, decide, or establish in advance.
predetermined input—a timed sequence of actions established in advance, the timed sequence of events adapted to validate or attempt to validate an authority of a user,
processor—a hardware, firmware, and/or software machine and/or virtual machine comprising a set of machine-readable instructions adaptable to perform a specific task. A processor acts upon information by manipulating, analyzing, modifying, converting, transmitting the information to another processor or an information device, and/or routing the information to an output device.
product—something produced by human or mechanical effort or by a natural process.
proposed—offered for consideration and/or acceptance.
purchase—to obtain one or more possession rights in exchange for money or an equivalent of money.
rejection—a refusal to accept an offer and/or proposed transaction.
restricted date—a day and/or plurality of days during which an offer and/or proposed transaction will be rejected and/or conditional.
restricted time—a time interval and/or plurality of time intervals during which an offer and/or proposed transaction will be rejected and/or conditional.
service—a performance of work and/or duties.
signal—detectable transmitted electrical and/or electromagnetic energy that can be used to carry a message and/or information that comprises one or more letters, words, numbers, characters, and/or symbols, etc. The message and/or information in a signal can be, for example digitally encrypted via for example, public key, PGP, and/or triple-DES, etc. As another example, the signal can be broadcast via, for example, a spread-spectrum technology such as, for example a frequency hopping or a direct-sequence spread-spectrum system.
subject matter—an identified type of good and/or service. For example, in an exemplary embodiment, an approval for the purchase of food can be granted, but a tobacco purchase can be rejected.
switch—a mechanical, electrical, and/or electronic device that opens and/or closes circuits, completes and/or breaks an electrical path, and/or selects paths and/or circuits.
symbol—any individual part of an identifier. A symbol can be, for example, a letter, number, keyboard symbol, and/or any other symbol.
time interval—a quantity of time between two instants, events, and/or states.
transaction—an exchange for one or more rights. Can include a purchase, lease, license (e.g., a right to access, use, perform, etc.), etc.
transmitter—an electronic device that generates and radiates a meaningful signal electronically and/or via electromagnetic waves.
unique identifier—a group of symbols that are unique to a particular user, vehicle, activity, category, and/or account.
user—any person that utilizes a device and/or service.
user-initiated—invoked by a user.
user interface—any device for rendering information to a user and/or requesting information from the user. A user interface includes at least one of textual, graphical, audio, video, animation, and/or haptic elements.
user-provided—supplied by a user.
valid—established as financially appropriate to utilize. For example, a financial account can be valid if the account exists with a sufficient available balance to pay a predetermined amount, a serial number can be valid if the number is one of a predetermined list of numbers and/or is of a predetermined format, and/or a user can be valid if the user is one of a predetermined list of users, etc.
vehicle—any type of mobile transport, such as a car, motorcycle, truck, half-track, train, boat, ship, airplane, helicopter, scooter, bicycle, ATV, unmanned vehicle, robot, etc.
vehicle-powered—supplied with energy provided by a vehicle.
wireless—any data communication technique that utilizes electromagnetic waves emitted by an antenna to communicate data (i.e., via an unguided medium), including such data communication techniques as sonar, radio, cellular, cellular radio, digital cellular radio, ELF, LF, MF, HF, VHF, UHF, SHF, EHF, radar, microwave, satellite microwave, laser, infrared, etc., and specifically excluding human voice radio transmissions, the data communication technique having a carrier frequency ranging from about 1 Hz to about 2×10¹⁴ Hz (about 200 teraHertz), including all values therebetween, such as for example, about 40 Hz, 6.010 kHz, 8.7 MHz, 4.518 GHz, 30 GHz, etc. and including all subranges therebetween, such as for example, from about 100 kHz to about 100 MHz, about 30 MHz to about 1 GHz, about 3 kHz to about 300 GHz, etc. Wireless communications can include analog and/or digital data, signals, and/or transmissions.

### DETAILED DESCRIPTION

Certain exemplary embodiments comprise a method comprising: receiving a signal from a transmitter, the signal comprising a unique identifier, the signal transmitted responsive to a predetermined input from a user, the signal requesting approval of a proposed transaction, transmitting the unique identifier to a central processor adapted to approve the proposed transaction if at least the unique identifier is associated with a valid financial account; and receiving an approval from the central processor to complete the proposed transaction, the proposed transaction involving the valid financial account associated with the unique identifier. Certain exemplary embodiments comprise a method comprising: at a central processor, receiving information originating from a transmitter, the information comprising a unique identifier, the information provided from the transmitter responsive to a predetermined input from a user, the information requesting approval of a proposed transaction; and if at least the unique identifier is associated with a valid financial account transmitting an approval to complete the proposed transaction, the proposed transaction involving the valid financial account associated with the unique identifier.

Certain exemplary embodiments provide an apparatus for transmitting a signal to a receiver in any manner, such as wirelessly. Certain exemplary embodiments can have a transmitter connected, incorporated, and/or integrated into previously existing circuitry of a vehicle. Certain exemplary embodiments can have the transmitter integrated into, incorporated into, and/or communicatively coupled to, an information device, which is not necessarily associated with, or located in, a vehicle. For example, the transmitter can be integrated into, incorporated into, and/or communicatively coupled to, an information device, such as a cellular phone, PDA, laptop, GPS transmitter, and/or CB radio, etc.

An exemplary embodiment of the transmitter can be integrated into an automobile's high beam activation circuitry. Flashing the high beams once can prime the transmitter in anticipation of sending a signal to a receiver. Flashing the high beams a second time can trigger the transmitter to send a wireless signal to a receiver. Certain exemplary embodiments can require that the high beams be flashed more than once in order to avoid accidental transmission of a wireless signal. For example, in a two-flash approach, the second flashing of the high beams can be required to occur within a few seconds of the first flashing. The time interval between the flashing of the first and second beams can be of any short time interval, such as from approximately 0.5 seconds to approximately 5 seconds, including all values therebetween, such as around 1.14, 1.5, 2.002, 2.6, and 3.25 seconds, etc., including all subranges therebetween, such as around 1.3 to about 2.47 seconds, etc. The number of high beam activations required to transmit a wireless signal to a receiver can be of any number from about 1 to around 10, including all values therebetween such as around 2, 3, 4, 5, 7, 9, etc., including all subranges therebetween, such as around 2 to around 5, about 1 to about 3, etc.

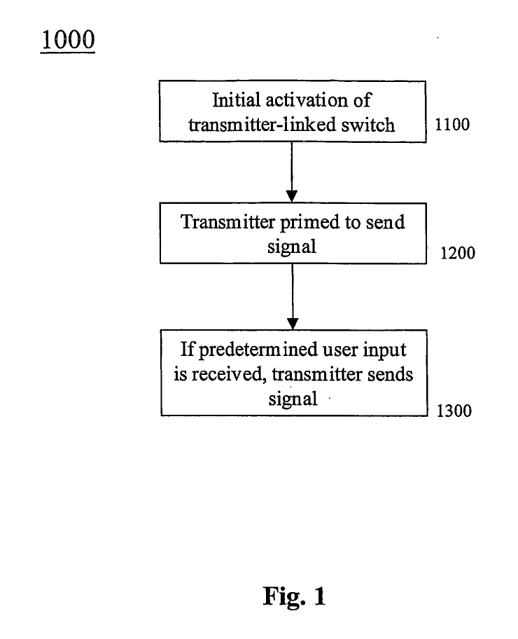

FIG. 1 is a flow chart of an exemplary embodiment of a method 1000 for utilizing a transmitter. At activity 1100, the initial activation of a transmitter-linked switch can occur. Certain exemplary embodiments of an activation mechanism for a transmitter can utilize a high beam switch in a vehicle, such as an automobile. A high beam can be activated by any known means, including a lever on a steering column, a button or a switch on a dashboard, a button on the floorboard, etc. Alternatively, the initiation of the sequence leading to the transmission of a wireless signal can be through any means practicable, such as voice activation, a retinal tracker, any dashboard button or switch, any steering column button or switch, etc. Installation of a transmitter can occur during manufacture of a new vehicle or alternatively as an after-market product in existing vehicles. In an exemplary embodiment wherein a high beam switch is utilized, a transmitter can be incorporated into the circuitry of a headlight system through connection to the headlight high beam positive lead and the headlight ground wire. The transmitter need not be polarized in certain exemplary embodiments.

Certain exemplary embodiments the initial activation of a transmitter-linked switch can comprise activation via providing a predetermined input to a device such as, for example a: vehicular accessory switch; vehicular accessory button; PDA; laptop computer; CB, mobile, walkie-talkie, and/or amateur radio; audio player such as an ipod, Rio, etc., having transmission capability;

digital camera with wireless transmission capability; a transmission device that is enabled with BlueTooth, 802.11a, 802.11b, 802.11g, WiFi, Ultrawideband, etc.; alarm system transmitter; garage door opener; gate access transmitter; cellular phone; built-in mobile phone; and/or keypad; etc.

Certain exemplary embodiments can have a transmitter located under the hood of a vehicle. Other exemplary embodiments can have the transmitter located anywhere that is practicable to incorporate the transmitter into appropriate circuitry. A transmitter can be made of components that are sufficiently durable to resist oil, water, dust, debris, wind, and/or extreme temperature. The transmitter can be of any size and material. The transmitter can be attached to the vehicle in a removable, semi-permanent, and/or permanent manner, and/or in an unsecured and/or secured manner. The more securely attached to the vehicle, the more difficult the transmitter can be to remove, thereby resisting its unauthorized use. For example, in certain embodiments, the transmitter can be secured to the vehicle via a lock or a transmitter disabling electronic security mechanism. Nevertheless, in certain embodiments, the transmitter can be removable from the vehicle, allowing the transmitter to be moved from one location to another and/or one vehicle to another, such as from a vehicle that has been disposed of to a newly acquired vehicle.

At activity 1200, the transmitter can be primed to transmit a signal. The transmitter can be primed via at least a first predetermined input from a user. In certain exemplary embodiments, the transmitter can be primed via a headlight high beam switch. The first time a high beam is flashed a bridge rectifier can polarize, which can cause a voltage regulator to drop the voltage to 5V. A capacitor can then charge and a microprocessor timer can start. A second activation of the high beam within a predetermined time interval can cause the microprocessor to trigger the transmitter to send a signal to a receiver. An exemplary embodiment of a microprocessor can require that the second activation of the high beams occur within around 2 seconds after the first activation. A period longer than the required interval can cause the microprocessor to reset to a neutral status.

In another exemplary embodiment, the transmitter can send a signal immediately upon receipt of a predetermined user input. In yet another exemplary embodiment, the transmitter can send a signal immediately upon receipt of a predetermined user input if an authentication code and/or biometric identifier has previously been input. In still another exemplary embodiment, receipt and/or recognition of any predetermined manifestation of user intent can cause the transmitter to send a signal.

At activity 1300, responsive to the predetermined user input, a signal, such as a wireless signal, can be transmitted. In certain exemplary embodiments, the signal can encode a unique “identifier”, such as a unique serial number. The identifier can comprise any number of individual symbols, such as around 3, 5, 6, 12, 100, 1200, etc. symbols. An exemplary embodiment of a transmitter can send a signal containing a hexadecimal serial number to a receiver. The hexadecimal serial number can be encrypted as part of a rolling code for additional security. Certain exemplary embodiments can use any known means of encrypting the signal, such as via the KeeLoq code-hopping authentication technology of Microchip Technology, Inc. of Chandler, Ariz. In certain embodiments, transmitter activation can also require that the key (or other vehicle access mechanism) be in the ignition (and/or be present and/or activated) so as to prevent use of the transmitter if the vehicle has been hot-wired and/or stolen.

Currently, some cars allow activation of the headlight high beam switch without the ignition being on, and others require the ignition to be on. Thus, in certain vehicles, without a key in the ignition and the ignition switch turned on, the headlight high beam switch can not be activated, and thereby, the transmitter can not be activated. Even for vehicles in which activation of the headlight high beam switch does not require the ignition being turned on via a key in the ignition switch, if the vehicle has been stolen such as via hot-wiring, the odds are that the thief does not know the car is equipped with the transmitter. In any event, if a car is reported as stolen, the receiver can be programmed to not recognize the transmitter (e.g., the transmitter's identity can be removed or disabled in the receiver's database) without the transmitter needing to be present, thereby disallowing actions that would otherwise be initiated by a receipt of a signal from the transmitter, such as entry to a garage, entry to a gated community, authorization of transactions, etc. In certain exemplary embodiments involving, for example, buying fast food, gas, etc. with a vehicle, a location of a vehicle and/or thief who uses the transmitter can be tracked through the computer that processes the transactions.

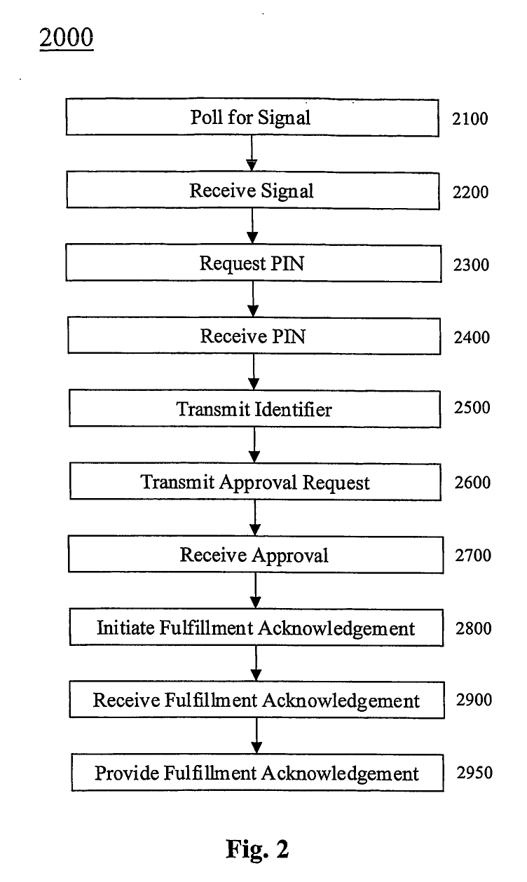

FIG. 2 is a flow chart of an exemplary embodiment of a method 2000 for utilizing a receiver. A receiver can be linked to, located adjacent to, and/or located within any device that can be activated through the transmission of a signal, such as a wireless signal. For example, a receiver can be located adjacent to an access gate. A receiver can be incorporated within a new device during manufacture or added as an after-market feature to existing devices.

An exemplary embodiment of a receiver can be incorporated as a component in a garage door system. For example, a receiver can be integral to, located in the wall behind, and/or located within the circuit of, a fixed pushbutton-style switch that can be mounted, for example, within a garage, home, building, etc. The activation of the pushbutton-style switch and/or the receiver can operate the garage door opener. Thus, a receiver can incorporate a push-button style switch to allow activation of a garage door opener without use of the transmitter. Certain exemplary embodiments of a receiver can be used to retrofit an existing garage door opener system. A retrofit can occur through connecting to the receiver the two low voltage wires that supply the power to the light on the original garage door opener pushbutton-style switch. In certain exemplary embodiments the two low voltage wires can be attached to the terminal screws on the back of the receiver without regard to polarity. For certain exemplary embodiments, a receiver can be designed to work within any power range, such as around 0.1 mA to about 20 A, including any value therebetween, such as around 0.5 mA, 2 mA, 10 mA, 0.5 A, 10 A, etc., and any subrange therebetween, such as about 0.9 to about 1.5 mA, around 1 A to around 3 A, etc.

An exemplary embodiment of a receiver can be incorporated into a commercial system and can be adapted to process transactions initiated by the transmitter. For example, the receiver can be associated with a toll road, car wash, dining business, bank, liquor store, fuel station, and/or park entry, etc.

At activity 2100, a receiver can poll for a signal. In certain exemplary embodiments, the receiver can passively listen for a signal. In certain exemplary embodiments, the receiver can transmit a signal inviting the transmitter to respond. The receiver can operate in a sleep mode that involves a signal polling frequency of 0.1 seconds. A polling frequency can be any short time interval from about 0.00001 seconds to about 5 seconds, including all values therebetween, such as around 0.025, 0.31, 0.45, 1.1, 1.67, and/or 2.4 seconds, etc, and any subrange therebetween, such as about 0.12 to about 0.24 seconds, 0.655 to about 0.9 seconds, etc.

At activity 2200, the signal can be received from the transmitter. The signal can comprise a unique identifier associated with the transmitter and/or a user. The unique identifier can be encrypted to improve security. In certain exemplary embodiments the signal can be from a vehicle-powered non-telephonic wireless transmitter. The wireless transmitter can be fixedly attached to a vehicle. In certain exemplary embodiments, the unique identifier is not a financial account number or a user-provided PIN. The received signal can be transmitted responsive to a predetermined input from the user. The predetermined input can be, for example, a predetermined number of headlight high beam switch activations within a predetermined time interval.

The signal can request approval of a proposed transaction. The transaction can involve the provision of a product, the provision of access to a physical location, the provision of access to a logical location, the provision of a license to access, use, play, view, perform, etc., and/or the provision of a service, etc. In certain exemplary embodiments, fulfillment of the transaction does not necessarily involve the transmitter. For example, in certain exemplary embodiments, the transmitter is not a cellular telephone, and thus, fulfillment of the transaction does not necessarily involve a telephone call.

At activity 2300, the receiver can request an additional verification of user identity such as a personal identification number (PIN). The PIN can provide an additional measure of security requiring a user to enter a predetermined code. The PIN can be entered via an information device, keypad, switch, and/or button accessible by the user and providable to the transmitter. For example, a PIN can be issued after the initial sign-up so that the first time a transmitter is used a PIN is required to be provided to authorize a transaction. Subsequent transactions could potentially not require provision of the PIN. Alternatively, for added security and/or to limit use of a transmitter, a PIN or other authentication means can be required for every transaction. In certain exemplary embodiments, a PIN can be required at periodic, aperiodic, regular, and/or random intervals.

In certain exemplary embodiments, a verification and/or authentication can be provided via an identification, financial, and/or biometric means, such as a fingerprint, driver's license, passport, identification card, smartcard, credit card, debit card, voiceprint authentication, and/or retinal scan. In certain exemplary embodiments, information regarding use preferences, account information, etc., can be provided to an entity associated with a secure website, such as by an owner of a vehicle with an attached transmitter. For example, the use of a transmitter can be limited to certain transactions, establishments, and/or scenarios. The allowable amount to spend during a single transaction, during a predetermined time period, and/or on particular goods and/or services can be capped. A user can specify that an additional verification and/or authentication means, such as those described above, be required and/or provided to initiate, authorize, and/or finalize a transaction otherwise manifested by a user input. Upon reception of a signal linked to a payment method, a receiver could process the payment. Alternatively, the receiver could send the payment information to a central processor that is adapted to manage commercial transactions.

At activity 2400, the receiver can receive the PIN number. In certain exemplary embodiments, the receiver can compare the PIN number to a predetermined list of PIN numbers associated with valid users. In certain exemplary embodiments, the receiver can forward the PIN number to another receiver, device, and/or entity adapted to compare the PIN number to a predetermined list of PIN numbers associated with valid users and/or accounts.

At activity 2500, the unique identifier can be transmitted to a receiver, device, and/or entity adapted to analyze the unique identifier. The unique identifier can be analyzed to determine if the unique identifier is on a list of valid unique identifiers. The list of valid unique identifiers can be indicative of a valid financial account.

In an exemplary embodiment, to limit the number of vehicles that can open a garage door, a unique serial number assigned to the transmitter and encoded in the wireless signal can be recognized by a receiver and/or central processor. The receiver and/or central processor can compare the serial number to an existing database of allowable serial numbers and then decide whether to admit or deny entrance through the garage door.

As another example, a central processor can decrypt and look up a serial number in a database to determine if a valid credit card account is associated with the serial number. If so, the central processor can authorize charging a transaction to the valid credit card account.

The receiver and/or central processor can store and recognize any quantity of serial numbers. The receiver and/or central processor can accept a transmitted signal, decode and/or decrypt the signal, and/or make a decision based on the received signal and/or information contained therein. Certain exemplary embodiments of the receiver and/or central processor can have an inherent, incorporated, attached, and/or networked storage capability. For exemplary embodiments where a greater number of serial numbers are to be stored, such as receivers and/or central processors used for gated communities or large parking structures, a receiver can be coupled to any storage device capable of maintaining a sufficiently large database, such as a memory, CD-ROM, DVD, EEPROM, etc., embodied in, for example, a PDA, a notebook computer, a personal computer, server, or mainframe. One or more storage devices can be located adjacent, near, and/or remote from the receiver and/or central processor. For example, a central storage device can be coupled to the receiver and/or central processor via a network, such as a cellular, wireless, switched, packet, private, public, Internet, intranet, local area, wide area, and/or other type of network.

At activity 2600, an approval request can be transmitted. The approval request can be for a transaction associated with the user such as a financial transaction, purchase, lease, license, etc. For example, if the user pulls a vehicle into a fueling station, the user can initiate a transaction relating to the purchase of fuel. Pursuant to receiving a unique identifier and/or an additional confirmation of identity such as a PIN, the receiver can request approval of the fuel purchase. The request can be, for example, for approval to charge a credit, charge, debit, checking, savings, hybrid, bank, trust, spending, brokerage, money market, etc., account associated with the user for the purchase of fuel.

At activity 2700, an approval can be received for the transaction. The approval can be either positive in allowing the transaction or negative in disallowing the transaction (e.g., a rejection). For example, for the aforementioned example wherein the user attempts to purchase fuel, the approval can comprise permission to charge an account for an amount equal to a value of fuel delivered. In certain exemplary embodiments, the charge can be disapproved and a rejection can be transmitted relating to the transaction.

For example, in an exemplary embodiment, if an entrance is authorized a receiver can signal for a garage door or gate to open. If the transmitted identification number does not allow opening of the garage door or gate, the receiver can instead resume sleep mode. Certain exemplary embodiments of a receiver can have a manual push button that can override the signal identification and authorization sequence. In other exemplary embodiments, a credit card or bank account can be charged for a commercial transaction. Authorization of payment can allow the receipt of a requested product or service, such as fuel; food; beverages; sundries; publications; dry-cleaned garments; flowers; pharmaceuticals and/or health care products; groceries; processed photographs; a car wash; an oil change; rented books, videos, or DVD's; parking; transportation; admission to an event; cash from an ATM; a “recharging” of a smartcard or other stored value device; etc.

In certain exemplary embodiments, the approval can result in a charge to an account without further action on the part of the user and/or a counter-party to a transaction. In certain exemplary embodiments, the approval can require at least one additional action and/or confirmation to take place before completing the transaction and/or charging the account. The approval can be received from an information device such as a central processor. In certain exemplary embodiments, the approval can be transmitted to the user responsive to the receiver receiving the approval. The approval can be rendered for the user via, for example, a user interface.

At activity 2800, a fulfillment acknowledgement can be initiated, such as by the user and/or the counter-party (or agent thereof), etc., the initiation transmitted via and/or to the transmitter, the receiver, and/or a device coupled to the transmitter, receiver, and/or central processor, etc. The fulfillment acknowledgement can be initiated responsive to information indicative of a transaction completion.

At activity 2900, the fulfillment acknowledgement can be received by the transmitter, the receiver, the central processor, and/or a device coupled to the transmitter, receiver, and/or central processor, etc. The fulfillment acknowledgement can confirm the completion of the transaction.

For example, once a vehicle has passed through a tollgate, a fulfillment acknowledgment can be sent via the receiver to the central processor so that an account associated with the user and/or vehicle is charged for the access provided to the vehicle. The fulfillment acknowledgement can comprise information confirming the transaction and/or details thereof.

At activity 2950, the fulfillment acknowledgement and/or an additional fulfillment acknowledgment, can be transmitted from the receiver. The fulfillment acknowledgement can be rendered to the user directly and/or indirectly pursuant to the transmission. The fulfillment acknowledgement can comprise a rendering and/or a receipt comprising information related to the transaction.

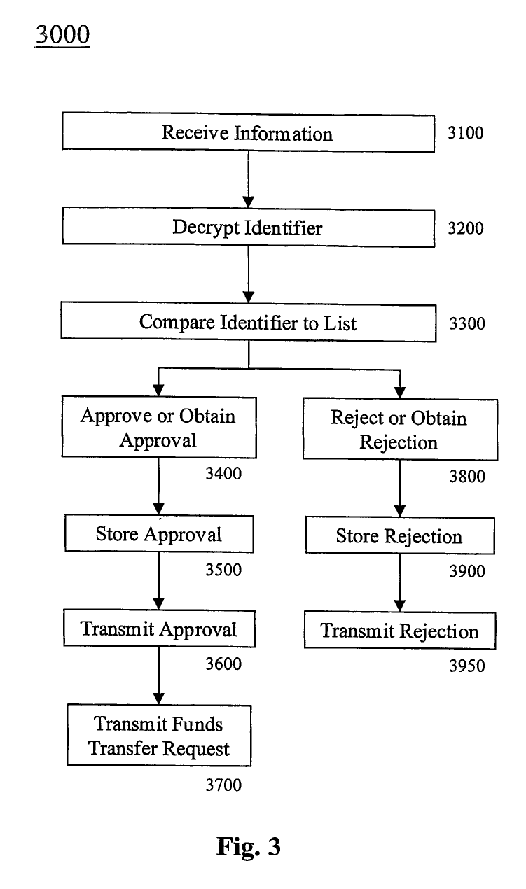

FIG. 3 is a flow chart of an exemplary embodiment of a method 3000 for utilizing a central processor. At activity 3100, the central processor can receive information from a transmitting and/or transceiving device. The information can comprise a unique identifier and/or a request for approval of a transaction. In certain exemplary embodiments, the information can originate from a vehicle-powered non-telephonic wireless transmitter fixedly attached to a vehicle. The information can comprise an encrypted unique identifier that does not comprise a financial account number or a user-provided PIN. The information can be provided from the wireless transmitter responsive to a predetermined input from a user. The information can request approval of a transaction. In certain exemplary embodiments, the fulfillment of the transaction can take place without involving the wireless transmitter.

At activity 3200, the unique identifier can be decrypted. The decryption can take place using a key associated with the encryption as in, for example, a code hopping technology, public key decryption, etc.

At activity 3300, the unique identifier can be compared to a preapproved and/or predetermined list of unique identifiers. In certain exemplary embodiments, the unique identifier can be associated with a valid financial account. Approval of the transaction can depend on a plurality of conditions such as the unique identifier being found in the predetermined list of unique identifiers.

At activity 3400, approval can be granted and/or obtained for the transaction. Approval can be granted, for example, if the user has a valid account and if certain predetermined conditions are met. Predetermined conditions can comprise that an account is in good standing and/or has a current balance not above a predetermined limit.

At activity 3500, the approval can be stored. The approval can be stored in a memory device. Storing the approval can provide documentation of a plurality of transactions should any of the transactions be questioned by the user. Storing the approval can provide information adapted to be reported periodically such as via a monthly statement relating to a financial account.

At activity 3600, the approval can be sent to a transceiver associated with the user and/or a vehicle associated with the user. In certain exemplary embodiments, the approval can be sent automatically. The approval can be sent to provide the user with information and/or a receipt related to the transaction.

At activity 3700, the central processor can approve and/or transmit a request to transfer funds. The request to transfer funds can be related to the financial account associated with the unique identifier. The request to transfer funds can occur contemporaneously with the approval of the transaction. In certain exemplary embodiments, the request to transfer funds can require an additional act and/or input pursuant to the approval of the transaction.

At activity 3800, the transaction can be rejected or a rejection of the transaction can be obtained. The transaction can be rejected due to the transaction exceeding a predetermined amount, an account associated with the unique identifier not being in good standing, the total amount of associated with one or more transactions exceeding a predetermined amount, the transaction exceeding a predetermined amount for a predetermined counter-party, the transaction exceeding a predetermined amount for a predetermined time interval for a predetermined counter-party, the proposed transaction being with a predetermined restricted counter party, the transaction involving a restricted subject matter, the transaction relating to a restricted time, and/or the transaction relating to a restricted date, etc.

Examples of rules resulting in transactional rejections can be illustrated by considering a parent of a college student. The parent can provide a plurality of restrictions to potential, proposed, and/or actual transactions. For example, a parent can mandate that the transaction be rejected if the amount exceeds $100. As another example, the transaction can be rejected when an attempt is made to charge the cost of the transaction to a previously used bank account that is closed. As an additional example, the transaction can be rejected if it would result in the student reaching a credit card account balance exceeding a predetermined limit of $5,000 set by the parent. As yet another example, the transaction can be rejected if the student attempts to charge over $50 at a particular fast food franchise. As still another example, the transaction can be rejected if the student attempts transactions that accumulate more than $200 in charges for a given week at a particular clothing business. As yet another example, the transaction can be rejected if the student attempts a purchase from a liquor store. As still another example, the transaction can be rejected if the student attempts to initiate the transaction during a scheduled class time. As another example, the transaction can be rejected if a student attempts to initiate the transaction for other than food or for more than $20 worth of food, on a day earmarked for studying for final examinations.

At activity 3900, the rejection can be stored. The rejection can be stored in a memory device. Storing the rejection can provide documentation of a plurality of rejections should any of the transactions be questioned by the user. Storing the rejection can provide information adapted to be reported periodically to an entity associated with the financial account. In certain exemplary embodiments, the entity associated with the financial account can automatically contact the user in order to resolve a number of rejections exceeding a predetermined number.

At activity 3950, the rejection can be transmitted to a transceiver associated with the user and/or a vehicle associated with the user. In certain exemplary embodiments, the rejection can be transmitted automatically. The rejection can be transmitted in order to provide the user with information and/or a receipt related to the transaction.

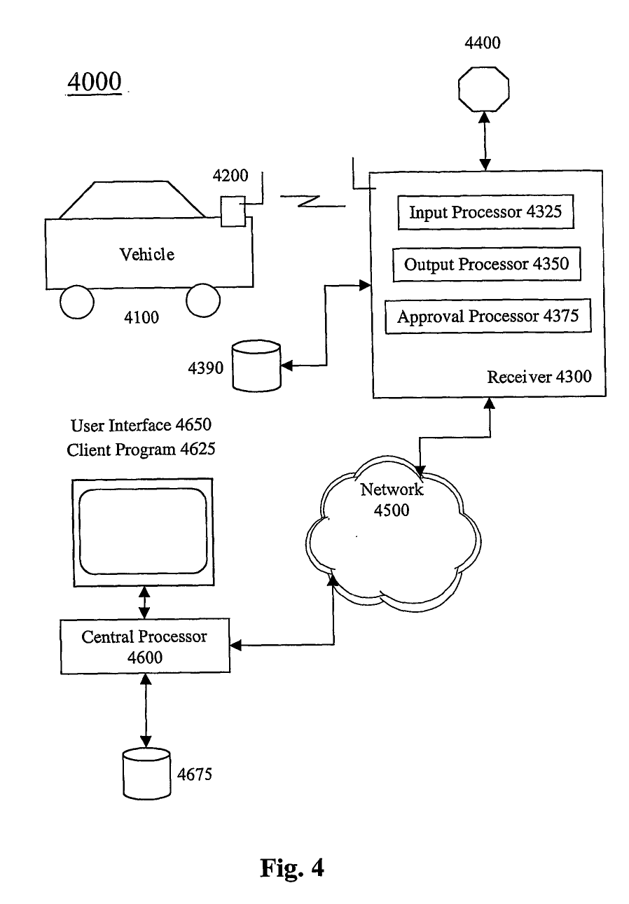

FIG. 4 is a block diagram of an exemplary embodiment of a system 4000. An exemplary embodiment of a vehicle 4100 can have a transmitter 4200 incorporated into an operator-activated device, such as a switch. An initial activation of a switch can prime transmitter 4200 to send a wireless signal. A second activation of the operator-activated device within a required time interval can cause transmitter 4200 to send a wireless signal to a receiver 4300. In an exemplary embodiment, a wireless signal can contain a unique encoded serial number assigned to transmitter 4200, vehicle 4100, and/or a user thereof.

After receiver 4300 receives a wireless signal from transmitter 4200, receiver 4300 can decode, decrypt, and/or compare the received serial number to a list of acceptable numbers. Alternatively, receiver 4300 can send the serial number to a database 4390 in a memory device, wherein the serial number can be checked against a list of acceptable numbers. Receiver 4300 and database 4390 can be linked via wired or wireless means. Database 4390 can then respond to receiver 4300 with an appropriate action based on acceptability of the received serial number, or with the results of a look-up of the received serial number. In an exemplary embodiment, database 4390 can signal to receiver 4300 that the received serial number is acceptable. Alternatively, database 4390 can provide to receiver 4300 an action command (e.g., “open door”, “lift gate”, “pump gas”, “complete transaction”, etc.) associated with the receiver and/or the signal received from the transmitter. Database 4390 can record the serial number, acceptability of the serial number, action command, etc., in an activity log. Responsive to the action command, receiver 4300 can then send an actuating signal to actuator 4400. Certain exemplary embodiments of an actuator 4400 can be a garage door opener or a mechanical gate for a gated community.

Receiver 4300 can comprise an input processor 4325, an output processor 4350, and an approval processor 4375. Input processor 4325 can be adapted to receive a signal. In certain exemplary embodiments, the signal can be from a vehicle-powered non-telephonic wireless transmitter fixedly attached to a vehicle. The signal can comprise a unique identifier. In certain exemplary embodiments, the unique identifier can be encrypted. In certain exemplary embodiments the unique identifier does not comprise a financial account number or a user-provided PIN. The signal can be transmitted responsive to a predetermined input from the user. The signal can request approval of a proposed transaction. In certain exemplary embodiments, the fulfillment of the proposed transaction does not involve the transmitter (e.g. a cellular telephone).

Output processor 4350 can be adapted to transmit the unique identifier to a central processor 4600. Approval processor 4375 can be adapted to receive an approval from central processor 4600 prior to completing the transaction. The transaction can involve a financial account associated with the unique identifier.

Receiver 4300 can be communicatively coupled to central processor 4600 via a network 4500. Central processor 4600 can comprise a user interface 4650 and/or a client program 4625. For example, client program 4625 can be adapted to compare the unique identifier to a list of unique identifiers stored on a memory device 4675 communicatively coupled to central processor 4600. In certain exemplary embodiments, central processor 4600 can approve or reject the transaction based upon results from client program 4625. In certain exemplary embodiments, central processor 4600 can be communicatively coupled to at least one additional information device. The additional information device can be adapted to approve or reject the transaction and communicate the approval or rejection via network 4500 to central processor 4600. In certain exemplary embodiments, client program 4625 can provide a notice and/or alert to an operator of central processor 4600 via user interface 4650. For example, if a serial number is received that is associated with a stolen vehicle, transmitter, and/or fraudulently used financial account, an alert can be provided via user interface 4650, so that the operator can implement appropriate actions, such as contacting law enforcement authorities. Alternatively, such appropriate actions can be taken automatically.

In certain embodiments, memory device 4675 and/or memory device 4390 can maintain a log of transactions and/or attempted transactions such as, for example, entries and exits for vehicles utilizing transmitter 4200 and receiver 4300. Memory device 4675 and/or memory device 4390 can be capable of obtaining a signal from receiver 4300 (which can be forwarding of a signal from transmitter 4200 or a different signal based on and/or triggered by the signal from transmitter 4200). Receiver 4300 and/or central processor 4600 can be adapted to decode and/or decrypt the signal (if necessary), perform a look-up based on the signal, and make a decision based on the stored information provided as a result of the look-up. Certain exemplary embodiments of memory device 4675 and/or memory device 4390 can have a list of acceptable serial numbers entered into one or more databases. Other exemplary embodiments of a memory device 4675 and/or memory device 4390 can allow memory device 4675 and/or memory device 4390 to collect and store a serial number after the first transmission by transmitter 4200.

Alternatively, receiver 4300 and/or central processor 4600 can delete an identification number from a list of authorized numbers. Management of transmitted identification numbers can be through any software, hardware, and/or firmware. Memory device 4675 and/or memory device 4390 can be linked to receiver 4300 and/or central processor 4600 through a cable, wire, and/or fiber wire and/or through any wireless and/or optical communications system.

Certain exemplary embodiments of system 4000 can allow a transmitted serial number to be linked to a credit card number, debit card number, bank account, and/or other account, such as a vehicle account, user account, consumer account, commercial account, etc. Such a system can allow the use of transmitter 4200 and receiver 4300 in consumer and/or commercial activities. An exemplary embodiment can have receiver 4300 located in, on, adjacent, and/or near a gas pump so that when a vehicle approaches the pump, flashing the high beams twice can authorize payment. Another exemplary embodiment can utilize receiver 4300 located in, on, adjacent, and/or near a drive-through restaurant, pharmacy, convenience store, car wash, etc. An order can be placed and payment authorized through flashing the high beams a predetermined number of times within a predetermined time interval. Exemplary embodiments of transmitter 4200 and receiver 4300 linked to a payment method can regard any activity involving payment and a vehicle, such as toll roads, parking lots, auto service stations, car washes, drive-in's, weigh stations, ferries, traffic violations, etc.

Central processor 4600 can transmit information related to the transaction to receiver 4300. The information can comprise whether the transaction was approved or rejected. In certain exemplary embodiments, receiver 4300 can forward the information from central processor 4600 to vehicle 4100 via transmitter 4200.

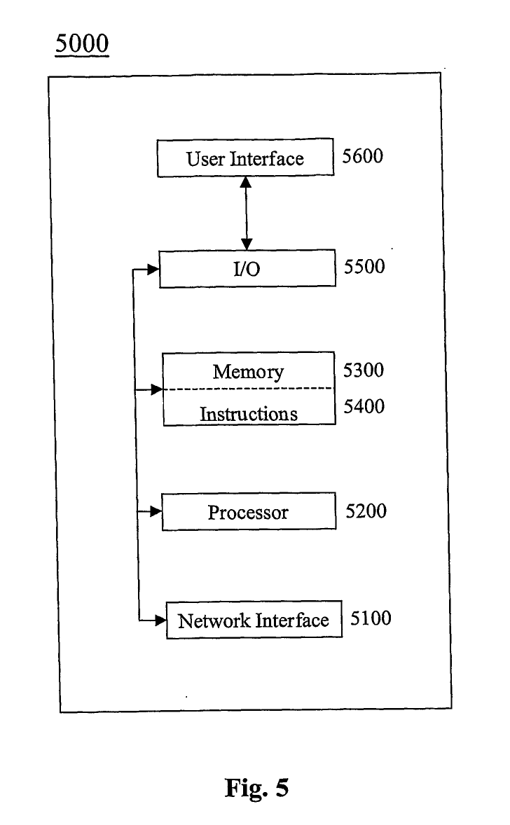

FIG. 5 is a block diagram of an information device 5000, which in certain operative embodiments can comprise, for example, receiver 4300 and/or central processor 4600 of FIG. 4. Information device 5000 can comprise any of numerous well-known components, such as for example, one or more network interfaces 5100, one or more processors 5200, one or more memories 5300 containing instructions 5400, one or more input/output (I/O) devices 5500, and/or one or more user interfaces 5600 coupled to I/O device 5500, etc.

In certain exemplary embodiments, via one or more user interfaces 5600, such as a graphical user interface, a user can view information related to a transaction processed via a transmitter, receiver, and/or central processor.

Still other embodiments will become readily apparent to those skilled in this art from reading the above-recited detailed description and drawings of certain exemplary embodiments. It should be understood that numerous variations, modifications, and additional embodiments are possible, and accordingly, all such variations, modifications, and embodiments are to be regarded as being within the spirit and scope of the appended claims. For example, regardless of the content of any portion (e.g., title, field, background, summary, abstract, drawing figure, etc.) of this application, unless clearly specified to the contrary, there is no requirement for the inclusion in any claim of the application of any particular described or illustrated activity or element, any particular sequence of such activities, or any particular interrelationship of such elements. Moreover, any activity can be repeated, any activity can be performed by multiple entities, and/or any element can be duplicated. Further, any activity or element can be excluded, the sequence of activities can vary, and/or the interrelationship of elements can vary. Accordingly, the descriptions and drawings are to be regarded as illustrative in nature, and not as restrictive. Moreover, when any number or range is described herein, unless clearly stated otherwise, that number or range is approximate. When any range is described herein, unless clearly stated otherwise, that range includes all values therein and all subranges therein. Any information in any material (e.g., a United States patent, United States patent application, book, article, etc.) that has been incorporated by reference herein, is only incorporated by reference to the extent that no conflict exists between such information and the other statements and drawings set forth herein. In the event of such conflict, including a conflict that would render a claim invalid, then any such conflicting information in such incorporated by reference material is specifically not incorporated by reference herein.

What is claimed is:

1. A method comprising:
receiving a signal from a vehicle-powered non-telephonic wireless transmitter fixedly attached to a vehicle, the signal comprising an encrypted unique identifier, the encrypted unique identifier not comprising a financial account number or a user-provided PIN, the signal transmitted responsive to a predetermined input from a user, the signal requesting approval of a proposed transaction, fulfillment of the proposed transaction not involving the transmitter;
transmitting the encrypted unique identifier to a central processor adapted to approve the proposed transaction if at least the unique identifier is associated with a valid financial account; and
receiving an approval from the central processor to complete the proposed transaction, the proposed transaction involving the valid financial account associated with the unique identifier.

2. The method of claim 1, further comprising transmitting a request for approval of the proposed transaction.

3. The method of claim 1, further comprising receiving an acknowledgment of fulfillment of the proposed transaction.

4. The method of claim 1, further comprising providing an acknowledgment of fulfillment of the proposed transaction to the transmitter.

5. The method of claim 1, further comprising initiating an acknowledgment of fulfillment of the proposed transaction to the user.

6. The method of claim 1, wherein the predetermined input comprises a predetermined number of headlight high beam switch activations within a predetermined time interval.

7. The method of claim 1, further comprising requesting a PIN from the user.

8. The method of claim 1, further comprising receiving a PIN from the user.

9. The method of claim 1, further comprising polling for the signal.

10. The method of claim 1, wherein the proposed transaction comprises provision of access to a physical location.

11. The method of claim 1, wherein the proposed transaction comprises provision of a product.

12. The method of claim 1, wherein the proposed transaction comprises provision of a service.

13. The method of claim 1, wherein encryption of the unique identifier utilizes a code hopping technique.

14. A system comprising:
an input processor adapted to receive a signal from a vehicle-powered non-telephonic wireless transmitter fixedly attached to a vehicle, the signal comprising an encrypted unique identifier, the encrypted unique identifier not comprising a financial account number or a user-provided PIN, the signal transmitted responsive to a predetermined input from a user, the signal requesting approval of a proposed transaction, fulfillment of the proposed transaction not involving the transmitter;
an output processor adapted to transmit the encrypted unique identifier to a central processor adapted to approve the proposed transaction if at least the unique identifier is associated with a valid financial account; and
an approval processor adapted to receive an approval from the central processor to complete the proposed transaction, the proposed transaction involving the valid financial account associated with the unique identifier.

15. A method comprising:
at a central processor, receiving information originating from a vehicle-powered non-telephonic wireless transmitter fixedly attached to a vehicle, the information comprising an encrypted unique identifier, the encrypted unique identifier not comprising a financial account number or a user-provided PIN, the information provided from the wireless transmitter responsive to a predetermined input from a user, the information requesting approval of a proposed transaction, fulfillment of the proposed transaction not involving the wireless transmitter; and
if at least the unique identifier is associated with a valid financial account automatically transmitting an approval to complete the proposed transaction, the proposed transaction involving the valid financial account associated with the unique identifier.

16. The method of claim 15, further comprising obtaining an approval of the proposed transaction.

17. The method of claim 15, further comprising storing an approval of the proposed transaction.

18. The method of claim 15, further comprising approving the proposed transaction.

19. The method of claim 15, further comprising obtaining a rejection of the proposed transaction.

20. The method of claim 15, further comprising transmitting a rejection of the proposed transaction.

21. The method of claim 15, further comprising transmitting a rejection of the proposed transaction if the proposed transaction exceeds a predetermined amount.

22. The method of claim 15, further comprising transmitting a rejection of the proposed transaction if a total amount associated with one or more transactions exceeds a predetermined amount.

23. The method of claim 15, further comprising transmitting a rejection of the proposed transaction if the proposed transaction exceeds a predetermined amount for a predetermined counter-party.

24. The method of claim 15, further comprising transmitting a rejection of the proposed transaction if the proposed transaction exceeds a predetermined amount for a predetermined time interval for a predetermined counter-party.

25. The method of claim 15, further comprising transmitting a rejection of the proposed transaction if a counter-party to the proposed transaction is a predetermined restricted counter-party.

26. The method of claim 15, further comprising transmitting a rejection of the proposed transaction if a subject matter of the proposed transaction is a predetermined restricted subject matter.

27. The method of claim 15, further comprising transmitting a rejection of the proposed transaction if a time of the proposed transaction is a predetermined restricted time.

28. The method of claim 15, further comprising transmitting a rejection of the proposed transaction if a date of the proposed transaction is a predetermined restricted date.

29. The method of claim 15, further comprising decrypting the encrypted unique identifier.

30. The method of claim 15, further comprising causing a comparison of the unique identifier with a list of unique identifiers associated with valid financial accounts.

31. The method of claim 15, transmitting instructions requesting a transfer of funds associated with the valid financial account responsive to the approval.

32. The method of claim 15, further comprising storing a rejection of the proposed transaction.

33. The method of claim 15, further comprising reporting a rejection of the proposed transaction.
